(19) United States
(12) Patent Application Publication
(10) Pub. No.: US 2024/0321174 A1
(43) Pub. Date: Sep. 26, 2024

(54) DISPLAY DEVICE AND METHOD OF DRIVING THE SAME

(71) Applicant: Samsung Display Co., LTD., Yongin-si (KR)

(72) Inventors: WONWOO JANG, Yongin-si (KR); SEUNGHO PARK, Yongin-si (KR)

(21) Appl. No.: 18/530,941

(22) Filed: Dec. 6, 2023

(30) Foreign Application Priority Data
Mar. 13, 2023 (KR) 10-2023-0032812

(51) Int. Cl. G09G 3/20; G06T 7/13

(52) U.S. Cl. CPC G09G 3/2096; G06T 7/13; G09G 2300/0452; G09G 2340/14

(57) ABSTRACT

A display device includes a display panel which displays an image based on an output image signal and a driving controller which generates the output image signal based on an input image signal. The driving controller includes an edge detector which generates an edge value for detecting an edge of the image using a plurality of filters having different sizes from each other, a weight calculator which calculates a weight based on the edge value, and a renderer which converts the input image signal to the output image signal based on the weight.

This application claims priority to Korean Patent Application No. 10-2023-0032812, filed on Mar. 13, 2023, and all the benefits accruing therefrom under 35 U.S.C. § 119, the content of which in its entirety is herein incorporated by reference.

### BACKGROUND

### 1. Field

Embodiments relate to a display device. More particularly, embodiments related to a display device applied to various electronic apparatuses and a method of driving the display device.

### 2. Description of the Related Art

A display device may include a display panel displaying an image. The display panel may include a plurality of pixels. Each of the pixels may emit light of one color among various colors (e.g., red, green, blue, etc.).

An arrangement of the plurality of pixels may be various. For example, some pixels of the plurality of pixels may be disposed in a first pixel row, and remaining pixels of the plurality of pixels may be disposed in a second pixel row adjacent to the first pixel row.

### SUMMARY

Embodiments provide a display device and a method of driving the display device for preventing quality of an image from being reduced due to an arrangement of pixels.

A display device in embodiments may include a display panel which displays an image based on an output image signal, and a driving controller which generates the output image signal based on an input image signal. The driving controller may include an edge detector which generates an edge value for detecting an edge of the image using a plurality of filters having different sizes from each other, a weight calculator which calculates a weight based on the edge value, and a renderer which converts the input image signal to the output image signal based on the weight.

In an embodiment, the edge detector may calculate the edge value based on a first edge value for detecting the edge of the image in a first direction and a second edge value for detecting the edge of the image in a second direction crossing the first direction.

In an embodiment, the edge detector may calculate the first edge value by performing intersection operation of a first sub-edge value calculated based on a first filter having a first size among the plurality of filters, a second sub-edge value calculated based on a second filter having a second size greater than the first size among the plurality of filters, and a third sub-edge value calculated based on a third filter having a third size greater than the second size among the plurality of filters. The edge detector may calculate the second edge value by performing intersection operation of a fourth sub-edge value calculated based on a fourth filter having the first size among the plurality of filters, a fifth sub-edge value calculated based on a fifth filter having the second size among the plurality of filters, and a sixth sub-edge value calculated based on a sixth filter having the third size among the plurality of filters.

In an embodiment, the first sub-edge value may be calculated by convolution operation of the input image signal and the first filter. The second sub-edge value may be calculated by convolution operation of the input image signal and the second filter. The third sub-edge value may be calculated by convolution operation of the input image signal and the third filter. The fourth sub-edge value may be calculated by convolution operation of the input image signal and the fourth filter. The fifth sub-edge value may be calculated by convolution operation of the input image signal and the fifth filter. The sixth sub-edge value may be calculated by convolution operation of the input image signal and the sixth filter.

In an embodiment, the first size, the second size, and the third size may be 3 by (×) 3, 5×5, and 7×7, respectively.

In an embodiment, the first filter, the second filter, the third filter, the fourth filter, the fifth filter, and the sixth filter may be

$$[ \begin{matrix}- 1 & - 1 & - 1 \\ 0 & 0 & 0 \\ 1 & 1 & 1\end{matrix} ] , [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , [ \begin{matrix}- 1 & 0 & 1 \\ - 1 & 0 & 1 \\ - 1 & 0 & 1\end{matrix} ] , \\ [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , and [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] , respectively .$$

In an embodiment, the edge detector may calculate the first edge value by performing intersection operation of a first sub-edge value calculated based on a first filter having a first size among the plurality of filters, a second sub-edge value calculated based on a second filter having a second size greater than the first size among the plurality of filters, a third sub-edge value calculated based on a third filter having a third size greater than the second size among the plurality of filters, and a fourth sub-edge value calculated based on a fourth filter having a fourth size greater than the third size among the plurality of filters. The edge detector may calculate the second edge value by performing intersection operation of a fifth sub-edge value calculated based on a fifth filter having the first size among the plurality of filters, a sixth sub-edge value calculated based on a sixth filter having the second size among the plurality of filters, a seventh sub-edge value calculated based on a seventh filter having the third size among the plurality of filters, and an eighth sub-edge value calculated based on an eighth filter having the fourth size among the plurality of filters.

In an embodiment, the first sub-edge value may be calculated by convolution operation of the input image signal and the first filter. The second sub-edge value may be calculated by convolution operation of the input image signal and the second filter. The third sub-edge value may be calculated by convolution operation of the input image signal and the third filter. The fourth sub-edge value may be calculated by convolution operation of the input image signal and the fourth filter. The fifth sub-edge value may be calculated by convolution operation of the input image signal and the fifth filter. The sixth sub-edge value may be calculated by convolution operation of the input image signal and the sixth filter.

The seventh sub-edge value may be calculated by convolution operation of the input image signal and the seventh filter. The eighth sub-edge value may be calculated by convolution operation of the input image signal and the eighth filter.

In an embodiment, the first size, the second size, the third size, and the fourth size may be 3×3, 5×5, 7×7, and 9×9, respectively.

In an embodiment, the first filter, the second filter, the third filter, the fourth filter, the fifth filter, the sixth filter, the seventh filter, and the eighth filter may be

$$[ \begin{matrix}- 1 & - 1 & - 1 \\ 0 & 0 & 0 \\ 1 & 1 & 1\end{matrix} ] , [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , \\ [ \begin{matrix}- 1 & - 1 & - 1 & - 1 & - 1 & - 1 & - 1 & - 1 & - 1 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 1 & 1 & 1 & 1 & 1 & 1 & 1 & 1 & 1\end{matrix} ] , [ \begin{matrix}- 1 & 0 & 1 \\ - 1 & 0 & 1 \\ - 1 & 0 & 1\end{matrix} ] , \\ [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] , and \\ \\ \\ [ \begin{matrix}- 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1\end{matrix} ] ,$$

respectively.

In an embodiment, the weight may increase as the edge value increases. The edge value and the weight may have a non-linear relationship.

In an embodiment, the display panel may include a first pixel, a second pixel, and a third pixel which emit light of different colors from each other. The second pixel may be disposed in a first pixel row. The first pixel and the third pixel may be disposed in a second pixel row adjacent to the first pixel row.

In an embodiment, the input image signal may include a first color signal, a second color signal, a third color signal corresponding to the first pixel, the second pixel, and the third pixel, respectively.

In an embodiment, the renderer may render the first color signal using a first rendering filter in which the weight is disposed in a first direction. The renderer may render the second color signal using a second rendering filter in which the weight is disposed in a second direction opposite to the first direction. The renderer may render the third color signal using a third rendering filter in which the weight is disposed in the first direction.

A method of driving a display device in embodiments may include generating an edge value for detecting an edge of an image using a plurality of filters having different sizes from each other, calculating a weight based on the edge value, and converting an input image signal to an output image signal based on the weight.

In an embodiment, the edge value may be calculated based on a first edge value for detecting the edge of the image in a first direction and a second edge value for detecting the edge of the image in a second direction crossing the first direction.

In an embodiment, the first edge value may be calculated by performing intersection operation of a first sub-edge value calculated based on a first filter having a first size among the plurality of filters, a second sub-edge value calculated based on a second filter having a second size greater than the first size among the plurality of filters, and a third sub-edge value calculated based on a third filter having a third size greater than the second size among the plurality of filters. The second edge value may be calculated by performing intersection operation of a fourth sub-edge value calculated based on a fourth filter having the first size among the plurality of filters, a fifth sub-edge value calculated based on a fifth filter having the second size among the plurality of filters, and a sixth sub-edge value calculated based on a sixth filter having the third size among the plurality of filters.

In an embodiment, the first sub-edge value may be calculated by convolution operation of the input image signal and the first filter. The second sub-edge value may be calculated by convolution operation of the input image signal and the second filter. The third sub-edge value may be calculated by convolution operation of the input image signal and the third filter. The fourth sub-edge value may be calculated by convolution operation of the input image signal and the fourth filter. The fifth sub-edge value may be calculated by convolution operation of the input image signal and the fifth filter. The sixth sub-edge value may be calculated by convolution operation of the input image signal and the sixth filter.

In an embodiment, the first size, the second size, and the third size may be 3×3, 5×5, and 7×7, respectively.

In an embodiment, the first filter, the second filter, the third filter, the fourth filter, the fifth filter, and the sixth filter may be

$$[ \begin{matrix}- 1 & - 1 & - 1 \\ 0 & 0 & 0 \\ 1 & 1 & 1\end{matrix} ] , [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , [ \begin{matrix}- 1 & 0 & 1 \\ - 1 & 0 & 1 \\ - 1 & 0 & 1\end{matrix} ] , [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , and \\ [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] ,$$

respectively.

In the display device and the method of driving the display device in the embodiments, only a relatively big edge of the image may be detected using the plurality of filters having different sizes from each other, and the image signal may be compensated, so that quality of the image of the display device having a predetermined arrangement of the pixels may be improved.

### BRIEF DESCRIPTION OF THE DRAWINGS

Illustrative, non-limiting embodiments will be more clearly understood from the following detailed description taken in conjunction with the accompanying drawings.

FIG. 1 is a block diagram illustrating an embodiment of a display device.

FIG. 2 is a plan view illustrating an embodiment of a display area of a display panel.

FIG. 3 is a diagram for describing color fringing phenomenon of an image.

FIG. 4 is a block diagram illustrating an embodiment of a driving controller.

FIG. 5 is a block diagram illustrating an edge detector of the driving controller in FIG. 4.

FIG. 6 is a diagram illustrating input image signals and edge values for various images.

FIG. 7 is a graph illustrating a look-up table of a weight calculator of the driving controller in FIG. 4.

FIGS. 8 to 10 are diagrams illustrating first to third rendering filters of a renderer of the driving controller in FIG. 4.

FIG. 11 is a diagram illustrating an input image and output images according to a comparative example and embodiment.

FIG. 12 is a flowchart illustrating an embodiment of a method of driving a display device.

FIG. 13 is a block diagram illustrating an embodiment of an electronic apparatus including a display device.

### DETAILED DESCRIPTION

Hereinafter, a display device and a method of driving a display device in embodiments of the disclosure will be described in more detail with reference to the accompanying drawings. The same or similar reference numerals will be used for the same elements in the accompanying drawings.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). The term such as “about” can mean within one or more standard deviations, or within +30%, 20%, 10%, 5% of the stated value, for example.

The term such as “detector” “calculator” or “renderer” as used herein is intended to mean a software component or a hardware component that performs a predetermined function. The hardware component may include a field-programmable gate array (“FPGA”) or an application-specific integrated circuit (“ASIC”), for example. The software component may refer to an executable code and/or data used by the executable code in an addressable storage medium. Thus, the software components may be object-oriented software components, class components, and task components, and may include processes, functions, attributes, procedures, subroutines, segments of program code, drivers, firmware, micro codes, circuits, data, a database, data structures, tables, arrays, or variables, for example.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

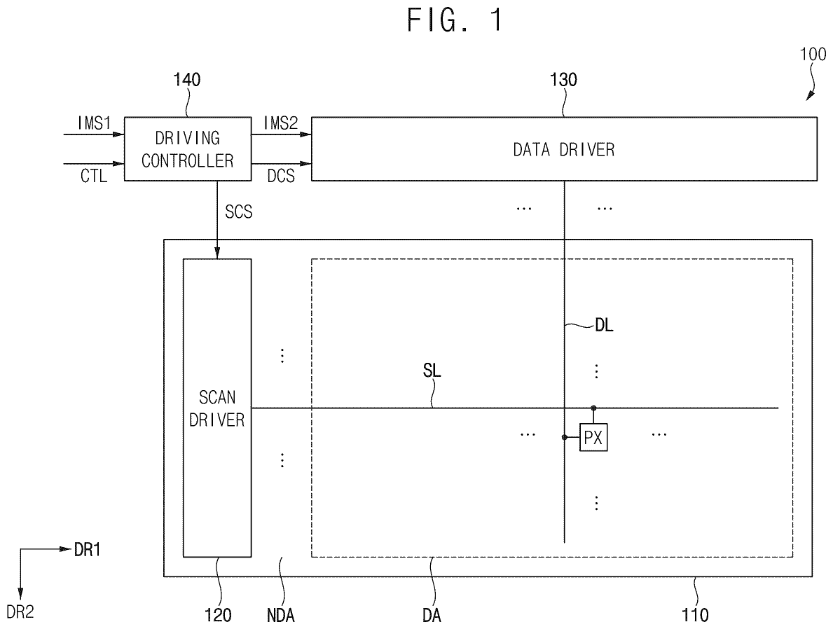

FIG. 1 is a block diagram illustrating an embodiment of a display device 100.

Referring to FIG. 1, a display device 100 may include a display panel 110, a scan driver 120, a data driver 130, and a driving controller 140.

The display panel 110 may display an image based on an output image signal IMS2. The display panel 110 may be a light-emitting display panel. In an embodiment, the display panel 110 may be an organic light-emitting display (“OLED”) panel, an inorganic light-emitting display panel, or a quantum-dot light-emitting display (“QLED”) panel. An emission layer of the organic light-emitting display panel may include organic light-emitting material. An emission layer of the inorganic light-emitting display panel may include inorganic light-emitting material. An emission layer of the quantum-dot light-emitting display panel may include quantum dots, quantum rods, or the like. Hereinafter, it will be described that the display panel 110 is the organic light-emitting display panel.

The display panel 110 may include scan lines SL, data lines DL, and pixels PX. The scan lines SL may extend from the scan driver 120 in a first direction DR1, and may be arranged in a second direction DR2. The second direction DR2 may cross the first direction DR1. The data lines DL may extend from the data driver 130 in the second direction DR2, and may be arranged in the first direction DR1.

The pixels PX may be disposed in a display area DA of the display panel 110. The display area DA may be an area where an image is displayed. A user may view the image through the display area DA. Each of the pixels PX may include a light-emitting element and a pixel circuit that controls light emission of the light-emitting element. In an embodiment, the light-emitting element may be an organic light-emitting diode. However, the disclosure is not limited thereto, and in another embodiment, the light-emitting element may be an inorganic light-emitting diode or a quantum-dot light-emitting diode.

Each of the pixels PX may be connected to a corresponding scan line among the scan lines SL, and may be connected to a corresponding data line among the data lines DL. Although FIG. 1 illustrates an embodiment in which one pixel PX is connected to one scan line, the disclosure is not limited thereto. In another embodiment, one pixel PX may be connected to two or more scan lines.

The scan driver 120 may output scan signals to the scan lines SL. The scan driver 120 may generate the scan signals in response to a scan control signal SCS. The scan driver 120 may be disposed in a non-display area NDA of the display panel 110. The non-display area NDA may be adjacent to the display area DA. In an embodiment, the non-display area NDA may surround the display area DA. In an embodiment, the scan driver 120 may be formed through the same process as the pixel circuit of the pixel PX.

The data driver 130 may output data signals to the data lines DL. The data driver 130 may generate the data signals in response to a data control signal DCS and the output image signal IMS2. The data driver 130 may convert the digital output image signal IMS2 to the analog data signal.

The driving controller 140 may output the scan control signal SCS to the scan driver 120, and may output the data control signal DCS and the output image signal IMS2 to the data driver 130. The driving controller 140 may generate the scan control signal SCS, the data control signal DCS, and the output image signal IMS2 based on an input image signal IMS1 and a control signal CTL. The driving controller 140 may convert the input image signal IMS1 to the output image signal IMS2 to meet an interface specification with the data driver 130.

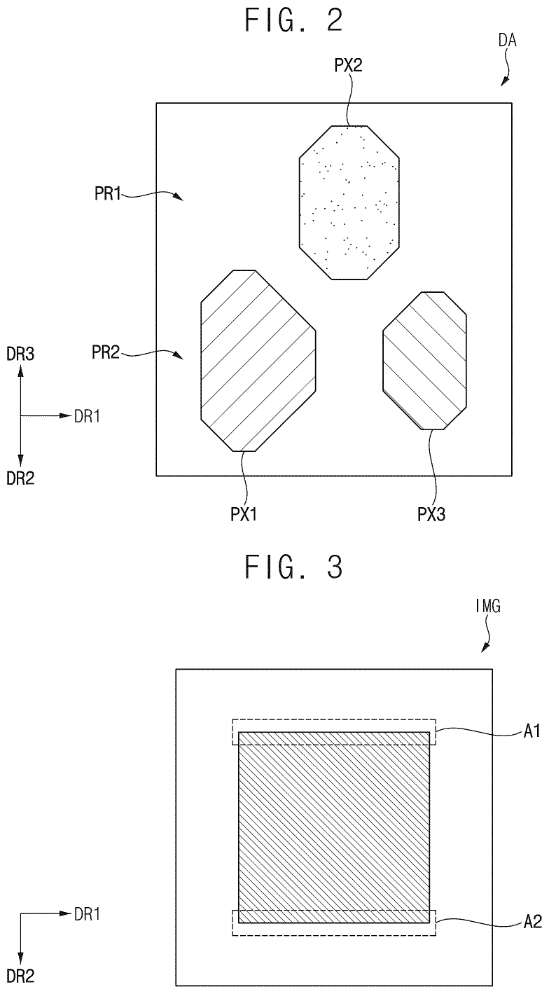

FIG. 2 is a plan view illustrating an embodiment of the display area DA of the display panel 110.

Referring to FIG. 2, the display panel 110 may include a first pixel PX1, a second pixel PX2, and a third pixel PX3 disposed in the display area DA. In an embodiment, the first to third pixels PX1, PX2, and PX3 may be repeatedly disposed along the first direction DR1 and the second direction DR2 in the display area DA.

Although FIG. 2 illustrates an embodiment in which each of the first to third pixels PX1, PX2, and PX3 has an octagonal planar shape, the disclosure is not limited thereto. In another embodiment, each of the first to third pixels PX1, PX2, and PX3 may have a planar shape such as a rectangle, a rhombus, a hexagon, or the like. FIG. 2 illustrates an embodiment in which planar areas of the first to third pixels PX1, PX2, and PX3 are different to each other, but the disclosure is not limited thereto. In another embodiment, planar areas of at least two of the first to third pixels PX1, PX2, and PX3 may be equal to each other.

The first to third pixels PX1, PX2, and PX3 may emit light of different colors. In an embodiment, the first pixel PX1 may emit light of a first color (e.g., red), the second pixel PX2 may emit light of a second color (e.g., green), and the third pixel PX3 may emit light of a third color (e.g., blue).

In an embodiment, the input image signal IMS1 may include a first color signal, a second color signal, and a third color signal. The first color signal, the second color signal, and the third color signal may correspond to the first pixel PX1, the second pixel PX2, and the third pixel PX3, respectively.

The second pixel PX2 may be disposed in a first pixel row PR1, and the first pixel PX1 and the third pixel PX3 may be disposed in a second pixel row PR2. The second pixel row PR2 may be adjacent to the first pixel row PR1 in the second direction DR2. When the first to third pixels PX1, PX2, and PX3 are arranged as illustrated in FIG. 2, a color fringing phenomenon may be recognized by a user.

FIG. 3 is a diagram for describing color fringing phenomenon of the image IMG.

Referring to FIGS. 2 and 3, an image IMG displayed by the display device 100 may include a white grayscale background image and a black grayscale box image. A magenta horizontal line may be displayed in a first boundary area A1 between the background image and the box image, and a green horizontal line may be displayed in a second boundary area A2 between the background image and the box image. The display of unwanted color lines in the boundary areas A1 and A2 may be due to the arrangement of the first to third pixels PX1, PX2, and PX3 illustrated in FIG. 2.

Since the first pixel PX1 emitting red light and the third pixel PX3 emitting blue light are disposed in the second pixel row PR2, the magenta horizontal line in which the red light and blue light are mixed may be viewed in the first boundary area A1. Since the second pixel PX2 emitting green light is disposed in the first pixel row PR1, the green horizontal line may be viewed in the second boundary area A2.

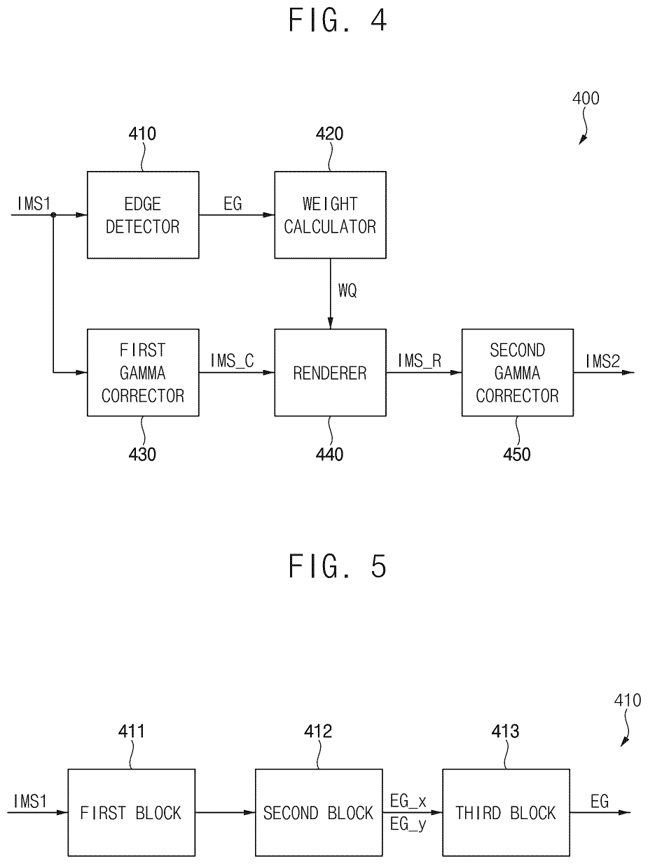

FIG. 4 is a block diagram illustrating an embodiment of a driving controller 400. The driving controller 400 in FIG. 4 may be the driving controller 140 in FIG. 1. FIG. 5 is a block diagram illustrating an edge detector 410 of the driving controller 400 in FIG. 4.

Referring to FIGS. 4 and 5, a driving controller 400 may include an edge detector 410, a weight calculator 420, a first gamma corrector 430, a renderer 440, and a second gamma corrector 450.

The edge detector 410 may generate an edge value EG for detecting an edge (or a boundary line) of an image. When a difference between input image signals IMS1 corresponding to two adjacent pixels among the pixels PX is greater than a reference value, the pixels may be determined as the edge of the image.

The edge detector 410 may generate the edge value EG using a plurality of filters (or masks) having different sizes from each other. The edge detector 410 may generate the edge value EG by performing convolution operations of the input image signal IMS1 and filters and intersection operations of results of the convolution operations.

The edge detector 410 may include a first block 411, a second block 412, and a third block 413.

In an embodiment, the edge detector 410 may generate the edge value EG using six filters.

The first block 411 may calculate a first sub-edge value by performing convolution operation of the input image signal IMS1 and a first filter having a first size, may calculate a second sub-edge value by performing convolution operation of the input image signal IMS1 and a second filter having a second size, and may calculate a third sub-edge value by performing convolution operation of the input image signal IMS1 and a third filter having a third size. Further, the first block 411 may calculate a fourth sub-edge value by performing convolution operation of the input image signal IMS1 and a fourth filter having the first size, may calculate a fifth sub-edge value by performing convolution operation of the input image signal IMS1 and a fifth filter having the second size, and may calculate a sixth sub-edge value by performing convolution operation of the input image signal IMS1 and a sixth filter having the third size. The second size may be greater than the first size, and the third size may be greater than the second size. The first to third filters may be filters for detecting an edge in the first direction DR1 (or a horizontal direction), and the fourth to sixth filters may be filters for detecting an edge in the second direction DR2 (or, a vertical direction).

In an embodiment, the first size, the second size, and the third size may be 3 by (×) 3, 5×5, and 7×7, respectively.

In an embodiment, the first filter g1x, the second filter g2x, the third filter g3x, the fourth filter g1y, the fifth filter g2y, and the sixth filter g3y may be

$$g 1 x = [ \begin{matrix}- 1 & - 1 & - 1 \\ 0 & 0 & 0 \\ 1 & 1 & 1\end{matrix} ] , g 2 x = [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ g 3 x = [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , g 1 y = [ \begin{matrix}- 1 & 0 & 1 \\ - 1 & 0 & 1 \\ - 1 & 0 & 1\end{matrix} ] , \\ g 2 y = [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , and g 3 y = [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] ,$$

respectively. However, each of the first filter g1x, the second filter g2x, the third filter g3x, the fourth filter g1y, the fifth filter g2y, and the sixth filter g3y is not limited thereto.

The second block 412 may calculate the first edge value EG_x by performing intersection operation of the first sub-edge value IMS1*g1x, the second sub-edge value IMS1*g2x, and the third sub-edge value IMS1*g3x, and may calculate the second edge value EG_y by performing intersection operation of the fourth sub-edge value IMS1*g1y, the fifth sub-edge value IMS1*g2y, and the sixth sub-edge value IMS1*g3y.

The first edge value EG_x may indicate an edge in the first direction DR1, and the first edge value EG_x may be calculated by Equation 1.

$$EG\_x = ( IMS 1 * g 1 x ) \times ( IMS 1 * g 2 x ) \times ( IMS 1 * g 3 x ) \qquad [ Equation 1 ]$$

The second edge value EG_y may indicate an edge in the second direction DR2, and the second edge value EG_y may be calculated by Equation 2.

$$EG\_y = ( IMS 1 * g 1 y ) \times ( IMS 1 * g 2 y ) \times ( IMS 1 * g 3 y ) \qquad [ Equation 2 ]$$

The third block 413 may calculate the edge value EG based on an absolute value of the first edge value EG_x and an absolute value of the second edge value EG_y. In an embodiment, the edge value EG may be calculated by Equation 3.

$$EG = \vert EG\_x \vert + \vert EG\_y \vert \qquad [ Equation 3 ]$$

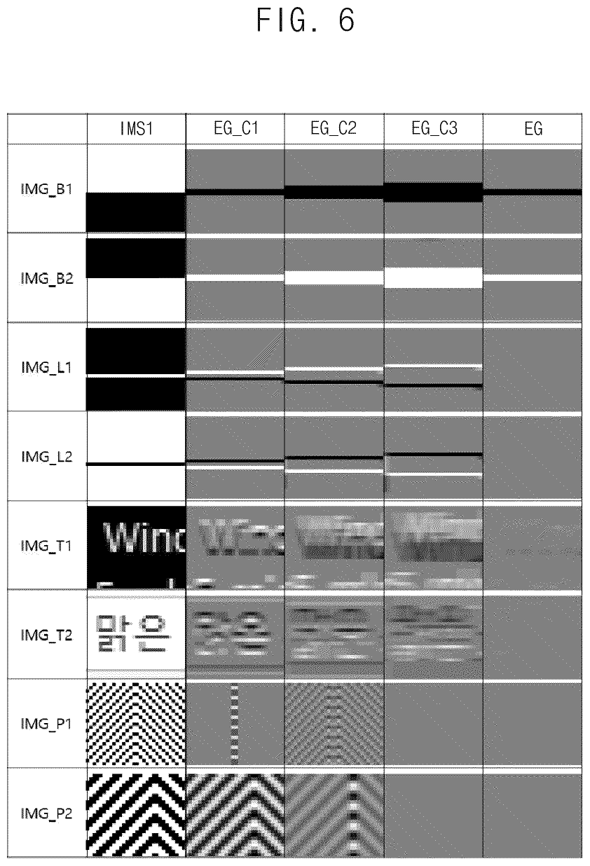

FIG. 6 is a diagram illustrating input image signals and edge values for various images.

FIG. 6 illustrates an input image signal IMS1, a first comparative edge value EG_C1, a second comparative edge value EG_C2, a third comparative edge value EG_C3, and an edge value EG for box images IMG_B1 and IMG_B2, line images IMG_L1 and IMG_L2, text images IMG_T1 and IMG_T2, and pattern images IMG_P1 and IMG_P2. The first comparative edge value EG_C1 may be generated by performing convolution operation of the input image signal IMS1 and a filter having the first size (e.g., 3×3 filter), the second comparative edge value EG_C2 may be generated by performing convolution operation of the input image signal IMS1 and a filter having the second size (e.g., 5×5 filter), the third comparative edge value EG_C3 may be generated by performing convolution operation of the input image signal IMS1 and a filter having the third size (e.g., 7×7 filter), and the edge value EG may be generated by performing intersection operation of a result of convolution operation of the input image signal IMS1 and a filter having the first size, a result of convolution operation of the input image signal IMS1 and a filter having the second size, and a result of convolution operation of the input image signal IMS1 and a filter having the third size. In other words, the edge value EG may be generated by performing intersection operation of the first comparative edge value EG_C1, the second comparative edge value EG_C2, and the third comparative edge value EG_C3. A portion having an edge value of −1 or 1 may be determined as an edge of an image. A black grayscale (e.g., 0 grayscale) illustrated as black in FIG. 6 may indicate that the first comparative edge value EG_C1, the second comparative edge value EG_C2, the third comparative edge value EG_C3, and the edge value EG are −1, a white grayscale (e.g., 255 grayscale) illustrated as white in FIG. 6 may indicate that the first comparative edge value EG_C1, the second comparative edge value EG_C2, the third comparative edge value EG_C3, and the edge value EG are 1, and a gray grayscale (e.g., 127 grayscale) illustrated as gray in FIG. 6 may indicate that the first comparative edge value EG_C1, the second comparative edge value EG_C2, the third comparative edge value EG_C3, and the edge value EG are 0. Accordingly, a portion having the first comparative edge value EG_C1, the second comparative edge value EG_C2, the third comparative edge value EG_C3, and the edge value EG of −1 or 1 may be detected as an edge of the image.

Referring to FIG. 6, the box images IMG_B1 and IMG_B2 may include a relatively big edge, and the line images IMG_L1 and IMG_L2, the text images IMG_T1 and IMG_T2, and the pattern images IMG_P1 and IMG_P2 may include a relatively small edge. Here, the relatively big edge may mean that a width of a portion displaying the same grayscale around a boundary of portions displaying different grayscales of the image is relatively wide, and the relatively small edge may mean that a width of a portion displaying the same grayscale around the boundary is relatively narrow. The box images IMG_B1 and IMG_B2 may include the relatively big edge because a width of a portion displaying the black or white grayscale around the boundary between a portion displaying the black grayscale and a portion displaying the white grayscale is greater than a reference value. Here, the reference value may vary according to the number of filters used. In an embodiment, the reference value may be three pixel rows or three pixel columns when using the 3×3 filter, the 5×5 filter, and the 7×7 filter, and the reference value may be four pixel rows or four pixel columns when using the 3×3 filter, the 5×5 filter, the 7×7 filter, and the 9×9 filter. The line images IMG_L1 and IMG_L2, the text images IMG_T1 and IMG_T2, and the pattern images IMG_P1 and IMG_P2 may include the relatively small edge because a width of a portion displaying the black or white grayscale around the boundary is less than the reference value. In a case in which the first comparative edge value EG_C1 is generated by performing convolution operation of the input image signal IMS1 and a filter having the first size and a case in which the second comparative edge value EG_C2 is generated by performing convolution operation of the input image signal IMS1 and a filter having the second size, the edge may be detected in all of the box images IMG_B1 and IMG_B2, the line images IMG_L1 and IMG_L2, the text images IMG_T1 and IMG_T2, and the pattern images IMG_P1 and IMG_P2. In a case in which the third comparative edge value EG_C3 is generated by performing convolution operation of the input image signal IMS1 and a filter having the third size, the edge may be detected in the box images IMG_B1 and IMG_B2, the line images IMG_L1 and IMG_L2, and the text images IMG_T1 and IMG_T2, and the edge may not be detected in the pattern images IMG_P1 and IMG_P2. When an edge of an image including a relatively small edge such as the line images IMG_L1 and IMG_L2, the text images IMG_T1 and IMG_T2, and the pattern images IMG_P1 and IMG_P2 is detected, phenomenon such as text blur may occur in the process of compensating the relatively small edge.

In a case in which the edge value EG is generated by performing intersection operation of the result of convolution operation of the input image signal IMS1 and a filter having the first size, the result of convolution operation of the input image signal IMS1 and a filter having the second size, and the result of convolution operation of the input image signal IMS1 and a filter having the third size, the edge may be detected only in the box images IMG_B1 and IMG_B2, and the edge may not be detected in the line images IMG_L1 and IMG_L2, the text images IMG_T1 and IMG_T2, and the pattern images IMG_P1 and IMG_P2. Accordingly, by detecting an edge of an image including a relatively big edge such as the box images IMG_B1 and IMG_B2, color fringing phenomenon due to the edge may be prevented. Further, by not detecting an edge of an image including a relatively small edge such as the line images IMG_L1 and IMG_L2, the text images IMG_T1 and IMG_T2, and the pattern images IMG_P1 and IMG_P2, phenomenon such as text blur occurred by compensation of the relatively small edge may be prevented.

Referring to FIGS. 4 and 5, in an embodiment, the edge detector 410 may generate the edge value EG using eight filters.

The first block 411 may calculate a first sub-edge value by performing convolution operation of the input image signal IMS1 and a first filter having a first size, may calculate a second sub-edge value by performing convolution operation of the input image signal IMS1 and a second filter having a second size, may calculate a third sub-edge value by performing convolution operation of the input image signal IMS1 and a third filter having a third size, and may calculate a fourth sub-edge value by performing convolution operation of the input image signal IMS1 and a fourth filter having a fourth size. Further, the first block 411 may calculate a fifth sub-edge value by performing convolution operation of the input image signal IMS1 and a fifth filter having the first size, may calculate a sixth sub-edge value by performing convolution operation of the input image signal IMS1 and a sixth filter having the second size, may calculate a seventh sub-edge value by performing convolution operation of the input image signal IMS1 and a seventh filter having the third size, and may calculate an eighth sub-edge value by performing convolution operation of the input image signal IMS1 and an eighth filter having the fourth size. The second size may be greater than the first size, the third size may be greater than the second size, and the fourth size may be greater than the third size. The first to fourth filters may be filters for detecting an edge in the first direction DR1, and the fifth to eighth filters may be filters for detecting an edge in the second direction DR2.

In an embodiment, the first size, the second size, the third size, and the fourth size may be 3×3, 5×5, 7×7, and 9×9, respectively.

In an embodiment, the first filter g1x, the second filter g2x, the third filter g3x, the fourth filter g4x, the fifth filter g1y, the sixth filter g2y, the seventh filter g3y, and the eighth filter g4y may be

$$g 1 x = [ \begin{matrix}- 1 & - 1 & - 1 \\ 0 & 0 & 0 \\ 1 & 1 & 1\end{matrix} ] , g 2 x = [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ g 3 x = [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , \\ g 4 x = [ \begin{matrix}- 1 & - 1 & - 1 & - 1 & - 1 & - 1 & - 1 & - 1 & - 1 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 1 & 1 & 1 & 1 & 1 & 1 & 1 & 1 & 1\end{matrix} ] , \\ g 1 y = [ \begin{matrix}- 1 & 0 & 1 \\ - 1 & 0 & 1 \\ - 1 & 0 & 1\end{matrix} ] , g 2 y = [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , \\ \\ g 3 y = [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] , and g 4 y = [ \begin{matrix}- 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1\end{matrix} ] ,$$

respectively. However, each of the first filter g1x, the second filter g2x, the third filter g3x, the fourth filter g4x, the fifth filter g1y, the sixth filter g2y, the seventh filter g3y, and the eighth filter g4y is not limited thereto.

The second block 412 may calculate the first edge value EG_x by performing intersection operation of the first sub-edge value IMS1*g1x, the second sub-edge value IMS1*g2x, the third sub-edge value IMS1*g3x, and the fourth sub-edge value IMS1*g4x, and may calculate the second edge value EG_y by performing intersection operation of the fifth sub-edge value IMS1*g1y, the sixth sub-edge value IMS1*g2y, the seventh sub-edge value IMS1*g3y, and the eighth sub-edge value IMS1*g4y.

The first edge value EG_x may indicate an edge in the first direction DR1, and the first edge value EG_x may be calculated by Equation 4.

$$EG\_x = ( IMS 1 * g 1 x ) \times ( IMS 1 * g 2 x ) \times ( IMS 1 * g 3 x ) \times ( IMS 1 * g 4 x ) \qquad [ Equation 4 ]$$

The second edge value EG_y may indicate an edge in the second direction DR2, and the second edge value EG_y may be calculated by Equation 5.

$$EG\_y = ( IMS 1 * g 1 y ) \times ( IMS 1 * g 2 y ) \times ( IMS 1 * g 3 y ) \times ( IMS 1 * g 4 y ) \qquad [ Equation 5 ]$$

The third block 413 may calculate the edge value EG based on an absolute value of the first edge value EG_x and an absolute value of the second edge value EG_y. In an embodiment, the edge value EG may be calculated by Equation 3.

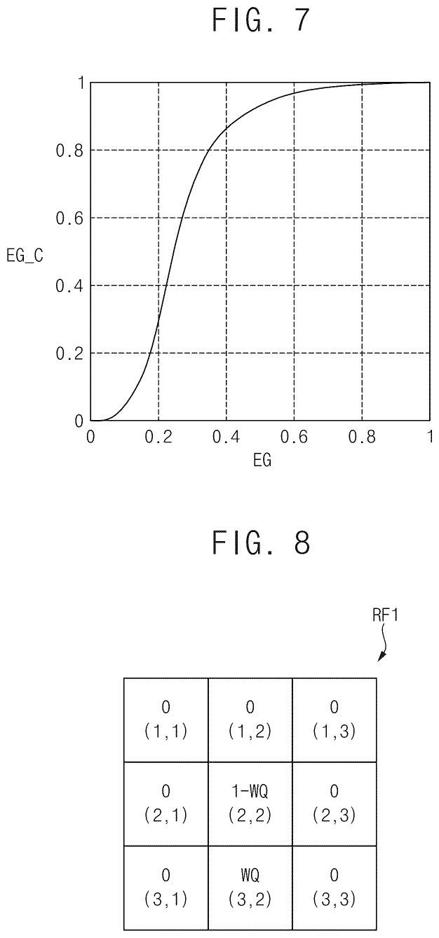

FIG. 7 is a graph illustrating a look-up table of the weight calculator 420 of the driving controller 400 in FIG. 4.

Referring to FIGS. 4 and 7, the weight calculator 420 may calculate a weight WQ based on the edge value EG. The weight WQ may be a compensation value for the input image signal IMS1. As the edge value EG increases, the weight WQ may increase. The edge value EG and the weight WQ may have a non-linear relationship.

The weight calculator 420 may include a look-up table that stores an edge compensation value EG_C corresponding to the edge value EG. As the edge value EG increases, the edge compensation value EG_C may increase. The edge value EG and the edge compensation value EG_C may have a non-linear relationship.

In an embodiment, the weight WQ may be calculated by multiplying the edge compensation value EG_C by a panel compensation value PN_C considering characteristics of the display panel 110. The weight WQ may be calculated by Equation 6.

$$W Q = EG\_C \times PN\_C \qquad [ Equation 6 ]$$

Referring to FIG. 4, the first gamma corrector 430 may correct the input image signal IMS1 with a first gamma characteristic, and may output a corrected image signal IMS_C. In an embodiment, the first gamma corrector 430 may correct the input image signal IMS1 with a gamma 2.2 curve characteristic.

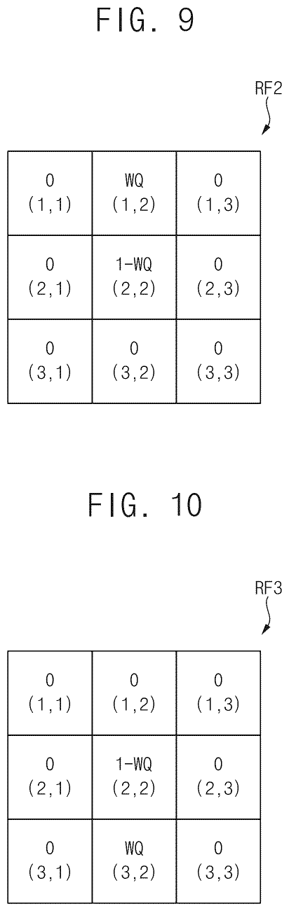

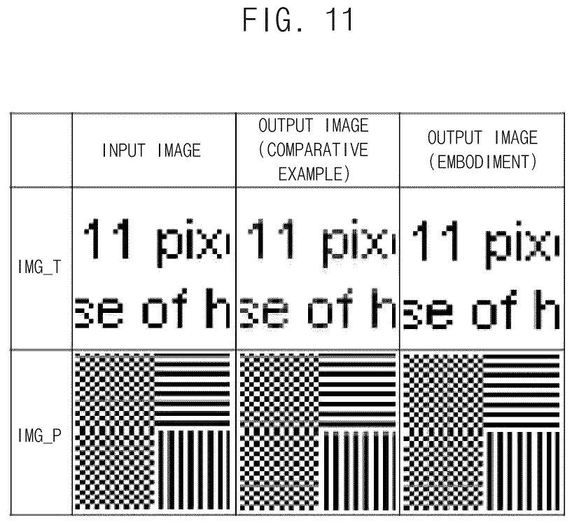

FIGS. 8 to 10 are diagrams illustrating first to third rendering filters RF1, RF2, and RF3 of the renderer 440 of the driving controller 400 in FIG. 4.

Referring to FIGS. 2, 4, and 8 to 10, the renderer 440 may render the corrected image signal IMS_C based on the weight WQ, and may output a rendered image signal IMS_R. The renderer 440 may render a first color signal included in the corrected image signal IMS_C by a first rendering filter RF1 including the weight WQ, may render a second color signal included in the corrected image signal IMS_C by a second rendering filter RF2 including the weight WQ, and may render a third color signal included in the corrected image signal IMS_C by a third rendering filter RF3 including the weight WQ. The renderer 440 may output the rendered image signal IMS_R by performing convolution operation of the first color signal and the first rendering filter RF1, convolution operation of the second color signal and the second rendering filter RF2, and convolution operation of the third color signal and the third rendering filter RF3.

Since the second pixel row PR2 is disposed in the second direction DR2 from the first pixel row PR1, the weight WQ may be disposed in the second direction DR2 in a rendering filter for rendering the corrected image signal IMS_C corresponding to pixels disposed in the second pixel row PR2, and the weight WQ may be disposed in a third direction DR3 opposite to the second direction DR2 in a rendering filter for rendering the corrected image signal IMS_C corresponding to pixels disposed in the first pixel row PR1.

Since the first pixel PX1 is disposed in the second pixel row PR2, WQ may be disposed as a rendering coefficient at a coordinate (3, 2) of the first rendering filter RF1. 1-WQ may be disposed as a rendering coefficient at a coordinate (2, 2) of the first rendering filter RF1. Since the second pixel PX2 is disposed in the first pixel row PR1, WQ may be disposed as a rendering coefficient at a coordinate (1, 2) of the second rendering filter RF2. 1-WQ may be disposed as a rendering coefficient at a coordinate (2, 2) of the second rendering filter RF2. Since the third pixel PX3 is disposed in the second pixel row PR2, WQ may be disposed as a rendering coefficient at a coordinate (3, 2) of the third rendering filter RF3. 1-WQ may be disposed as a rendering coefficient at a coordinate (2, 2) of the third rendering filter RF3.

Referring to FIG. 4, the second gamma corrector 450 may correct the rendered image signal IMS_R with a second gamma characteristic, and may output the output image signal IMS2. In an embodiment, the second gamma corrector 450 may correct the rendered image signal IMS_R with a gamma 0.45 curve characteristic.

In an embodiment, the driving controller 400 may not include the first gamma corrector 430 and the second gamma corrector 450. In such an embodiment, the renderer 440 may convert the input image signal IMS1 to the output image signal IMS2 based on the weight WQ.

In an embodiment, the driving controller 400 may not include one of the first gamma corrector 430 and the second gamma corrector 450.

FIG. 11 is a diagram illustrating an input image and output images according to a comparative example and embodiment. FIG. 11 may illustrate a text image IMG_T and a pattern image IMG_P.

Referring to FIG. 11, a text image IMG_T and a pattern image IMG_P may include a relatively small edge. In a comparative example, an edge of an image may be detected by performing convolution operation of an input image signal corresponding to the input image and a filter having a first size (e.g., 3×3 filter). When the edge is detected using only a filter having the first size, an edge may be detected in both the text image IMG_T and the pattern image IMG_P. In the comparative example, when the edge of the image including a relatively small edge such as the text image IMG_T and the pattern image IMG_P is detected, as illustrated in FIG. 11, a phenomenon such as blur may occur in the process of compensating the relatively small edge.

In an embodiment, an edge of an image may be detected by intersection operation of a result of convolution operation of an input image signal corresponding to the input image and a filter having the first size, a result of convolution operation of the input image signal and a filter having a second size (e.g., 5×5 filter), and a result of convolution operation of the input image signal and a filter having a third size (e.g., 7×7 filter). When the edge is detected using the filter having the first size, the filter having the second size, and the filter having the third size, an edge may not be detected in both the text image IMG_T and the pattern image IMG_P. Accordingly, in the embodiment, the edge of the image including a relatively small edge, such as the text image IMG_T and the pattern image IMG_P, may not be detected, and as illustrated in FIG. 11, a phenomenon such as blur due to compensation of the relatively small edge may not occur.

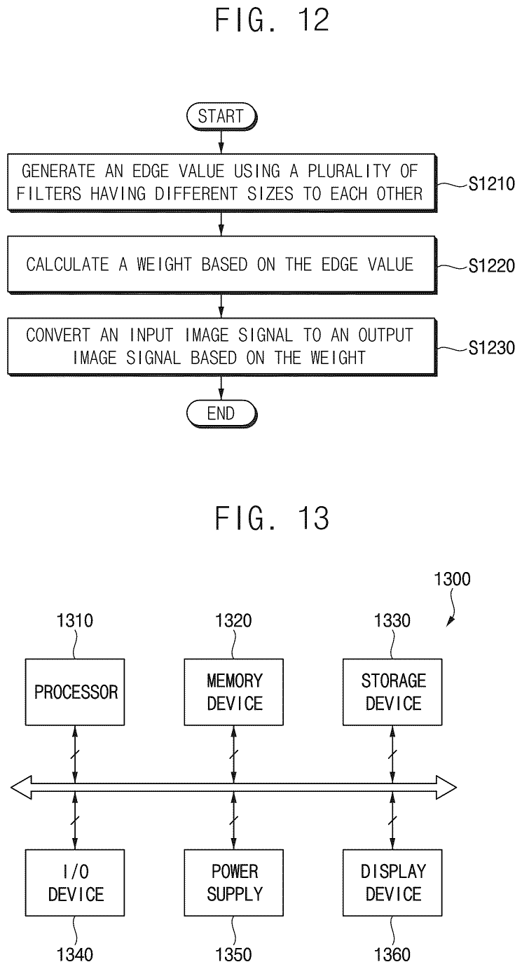

FIG. 12 is a flowchart illustrating an embodiment of a method of driving a display device.

Referring to FIGS. 4, 5, and 12, in a method of driving the display device, the edge detector 410 may generate the edge value EG for detecting an edge of an image using a plurality of filters having different sizes (S1210). The edge detector 410 may generate the edge value EG by performing convolution operations of the input image signal IMS1 and filters and intersection operations of results of the convolution operations.

In an embodiment, the first block 411 may calculate a first sub-edge value by performing convolution operation of the input image signal IMS1 and a first filter having a first size, may calculate a second sub-edge value by performing convolution operation of the input image signal IMS1 and a second filter having a second size, and may calculate a third sub-edge value by performing convolution operation of the input image signal IMS1 and a third filter having a third size. Further, the first block 411 may calculate a fourth sub-edge value by performing convolution operation of the input image signal IMS1 and a fourth filter having the first size, may calculate a fifth sub-edge value by performing convolution operation of the input image signal IMS1 and a fifth filter having the second size, and may calculate a sixth sub-edge value by performing convolution operation of the input image signal IMS1 and a sixth filter having the third size. The second size may be greater than the first size, and the third size may be greater than the second size.

In an embodiment, the first size, the second size, and the third size may be 3×3, 5×5, and 7×7, respectively.

In an embodiment, the first filter g1x, the second filter g2x, the third filter g3x, the fourth filter g1y, the fifth filter g2y, and the sixth filter g3y may be

$$g 1 x = [ \begin{matrix}- 1 & - 1 & - 1 \\ 0 & 0 & 0 \\ 1 & 1 & 1\end{matrix} ] , g 2 x = [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ g 3 x = [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , g 1 y = [ \begin{matrix}- 1 & 0 & 1 \\ - 1 & 0 & 1 \\ - 1 & 0 & 1\end{matrix} ] , \\ g 2 y = [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , and g 3 y = [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] ,$$

respectively. However, each of the first filter g1x, the second filter g2x, the third filter g3x, the fourth filter g1y, the fifth filter g2y, and the sixth filter g3y is not limited thereto.

The second block 412 may calculate the first edge value EG_x by performing intersection operation of the first sub-edge value IMS1*g1x, the second sub-edge value IMS1*g2x, and the third sub-edge value IMS1*g3x, and may calculate the second edge value EG_y by performing intersection operation of the fourth sub-edge value IMS1*g1y, the fifth sub-edge value IMS1*g2y, and the sixth sub-edge value IMS1*g3y.

The first edge value EG_x may indicate an edge in the first direction DR1, and the first edge value EG_x may be calculated by Equation 1. The second edge value EG_y may indicate an edge in the second direction DR2, and the second edge value EG_y may be calculated by Equation 2.

The third block 413 may calculate the edge value EG based on the first edge value EG_x and the second edge value EG_y. In an embodiment, the edge value EG may be calculated by Equation 3.

The weight calculator 420 may calculate a weight WQ based on the edge value EG (S1220). As the edge value EG increases, the weight WQ may increase. The edge value EG and the weight WQ may have a non-linear relationship.

In an embodiment, the weight WQ may be calculated by multiplying the edge compensation value EG_C by a panel compensation value PN_C considering characteristics of the display panel 110. The weight WQ may be calculated by Equation 6.

The renderer 440 may convert the input image signal IMS1 to the output image signal IMS2 based on the weight WQ (S1230).

FIG. 13 is a block diagram illustrating an embodiment of an electronic apparatus 1300 including a display device.

Referring to FIG. 13, an electronic apparatus 1300 may include a processor 1310, a memory device 1320, a storage device 1330, an input/output (“I/O”) device 1340, a power supply 1350, and a display device 1360. The display device 1360 may correspond to the display device 100 in FIG. 1. The electronic apparatus 1300 may further include a plurality of ports for communicating with a video card, a sound card, a memory card, a universal serial bus (“USB”) device, etc.

The processor 1310 may perform particular calculations or tasks. In an embodiment, the processor 1310 may be a microprocessor, a central processing unit (“CPU”), or the like. The processor 1310 may be coupled to other components via an address bus, a control bus, a data bus, or the like. In an embodiment, the processor 1310 may be coupled to an extended bus such as a peripheral component interconnection (“PCI”) bus. In an embodiment, the processor 1310 may include at least one of the edge detector 410, the weight calculator 420, the first gamma corrector 430, the renderer 440, and the second gamma corrector 450, which are illustrated in FIG. 4.

The memory device 1320 may store data for operations of the electronic apparatus 1300. In an embodiment, the memory device 1320 may include a non-volatile memory device such as an erasable programmable read-only memory (“EPROM”) device, an electrically erasable programmable read-only memory (“EEPROM”) device, a flash memory device, a phase change random access memory (“PRAM”) device, a resistance random access memory (“RRAM”) device, a nano floating gate memory (“NFGM”) device, a polymer random access memory (“PoRAM”) device, a magnetic random access memory (“MRAM”) device, a ferroelectric random access memory (“FRAM”) device, etc., and/or a volatile memory device such as a dynamic random access memory (“DRAM”) device, a static random access memory (“SRAM”) device, a mobile DRAM device, etc. In an embodiment, the memory device 1320 may store the edge value EG and weight WQ, which are illustrated in FIG. 4.

The storage device 1330 may include a solid state drive (“SSD”) device, a hard disk drive (“HDD”) device, a compact disc read-only memory (“CD-ROM”) device, or the like. The I/O device 1340 may include an input device such as a keyboard, a keypad, a touchpad, a touch-screen, a mouse device, etc., and an output device such as a speaker, a printer, etc. The power supply 1350 may supply a power desired for the operation of the electronic apparatus 1300. The display device 1360 may be coupled to other components via the buses or other communication links.

In the display device 1360, only relatively big edges of an image may be detected using a plurality of filters having different sizes from each other, and an image signal may be compensated, so that quality of the image of the display device 1360 having a predetermined arrangement of pixels may be improved.

The display device in the embodiments may be applied to a display device included in a computer, a notebook, a mobile phone, a smart phone, a smart pad, a portable media player (“PMP”), a personal digital assistance (“PDA”), a motion pictures expert group layer III (“MP3”) player, or the like.

Although the display devices and the display devices in the embodiments have been described with reference to the drawings, the illustrated embodiments are examples, and may be modified and changed by a person having ordinary knowledge in the relevant technical field without departing from the technical spirit described in the following claims.

What is claimed is:

1. A display device, comprising:
a display panel which displays an image based on an output image signal; and
a driving controller which generates the output image signal based on an input image signal, the driving controller including:
an edge detector which generates an edge value for detecting an edge of the image using a plurality of filters having different sizes from each other;
a weight calculator which calculates a weight based on the edge value; and
a renderer which converts the input image signal to the output image signal based on the weight.

2. The display device of claim 1, wherein the edge detector calculates the edge value based on a first edge value for detecting the edge of the image in a first direction and a second edge value for detecting the edge of the image in a second direction crossing the first direction.

3. The display device of claim 2, wherein the edge detector calculates the first edge value by performing intersection operation of a first sub-edge value calculated based on a first filter having a first size among the plurality of filters, a second sub-edge value calculated based on a second filter having a second size greater than the first size among the plurality of filters, and a third sub-edge value calculated based on a third filter having a third size greater than the second size among the plurality of filters, and
wherein the edge detector calculates the second edge value by performing intersection operation of a fourth sub-edge value calculated based on a fourth filter having the first size among the plurality of filters, a fifth sub-edge value calculated based on a fifth filter having the second size among the plurality of filters, and a sixth sub-edge value calculated based on a sixth filter having the third size among the plurality of filters.

4. The display device of claim 3, wherein the first sub-edge value is calculated by convolution operation of the input image signal and the first filter,
wherein the second sub-edge value is calculated by convolution operation of the input image signal and the second filter,
wherein the third sub-edge value is calculated by convolution operation of the input image signal and the third filter,
wherein the fourth sub-edge value is calculated by convolution operation of the input image signal and the fourth filter,
wherein the fifth sub-edge value is calculated by convolution operation of the input image signal and the fifth filter, and
wherein the sixth sub-edge value is calculated by convolution operation of the input image signal and the sixth filter.

5. The display device of claim 3, wherein the first size, the second size, and the third size are 3 by 3, 5 by 5, and 7 by 7, respectively.

6. The display device of claim 3, wherein the first filter, the second filter, the third filter, the fourth filter, the fifth filter, and the sixth filter are
$$[ \begin{matrix}- 1 & - 1 & - 1 \\ 0 & 0 & 0 \\ 1 & 1 & 1\end{matrix} ] , [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , [ \begin{matrix}- 1 & 0 & 1 \\ - 1 & 0 & 1 \\ - 1 & 0 & 1\end{matrix} ] , [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , and \\ \\ \\ [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] ,$$
respectively.

7. The display device of claim 2, wherein the edge detector calculates the first edge value by performing intersection operation of a first sub-edge value calculated based on a first filter having a first size among the plurality of filters, a second sub-edge value calculated based on a second filter having a second size greater than the first size among the plurality of filters, a third sub-edge value calculated based on a third filter having a third size greater than the second size among the plurality of filters, and a fourth sub-edge value calculated based on a fourth filter having a fourth size greater than the third size among the plurality of filters, and
wherein the edge detector calculates the second edge value by performing intersection operation of a fifth sub-edge value calculated based on a fifth filter having the first size among the plurality of filters, a sixth sub-edge value calculated based on a sixth filter having the second size among the plurality of filters, a seventh sub-edge value calculated based on a seventh filter having the third size among the plurality of filters, and an eighth sub-edge value calculated based on an eighth filter having the fourth size among the plurality of filters.

8. The display device of claim 7, wherein the first sub-edge value is calculated by convolution operation of the input image signal and the first filter,
wherein the second sub-edge value is calculated by convolution operation of the input image signal and the second filter,
wherein the third sub-edge value is calculated by convolution operation of the input image signal and the third filter,
wherein the fourth sub-edge value is calculated by convolution operation of the input image signal and the fourth filter,
wherein the fifth sub-edge value is calculated by convolution operation of the input image signal and the fifth filter,
wherein the sixth sub-edge value is calculated by convolution operation of the input image signal and the sixth filter,
wherein the seventh sub-edge value is calculated by convolution operation of the input image signal and the seventh filter, and
wherein the eighth sub-edge value is calculated by convolution operation of the input image signal and the eighth filter.

9. The display device of claim 7, wherein the first size, the second size, the third size, and the fourth size are 3 by 3, 5 by 5, 7 by 7, and 9 by 9, respectively.

10. The display device of claim 7, wherein the first filter, the second filter, the third filter, the fourth filter, the fifth filter, the sixth filter, the seventh filter, and the eighth
$$filter are [ \begin{matrix}- 1 & - 1 & - 1 \\ 0 & 0 & 0 \\ 1 & 1 & 1\end{matrix} ] , [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , \\ [ \begin{matrix}- 1 & - 1 & - 1 & - 1 & - 1 & - 1 & - 1 & - 1 & - 1 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 0 & 0 & 0 & 0 & 0 & 0 & 0 & 0 & 0 \\ 1 & 1 & 1 & 1 & 1 & 1 & 1 & 1 & 1\end{matrix} ] , [ \begin{matrix}- 1 & 0 & 1 \\ - 1 & 0 & 1 \\ - 1 & 0 & 1\end{matrix} ] , \\ [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] , and \\ \\ \\ [ \begin{matrix}- 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1 \\ - 1 & 0 & 0 & 0 & 0 & 0 & 0 & 0 & 1\end{matrix} ] ,$$
respectively.

11. The display device of claim 1, wherein the weight increases as the edge value increases, and
wherein the edge value and the weight have a non-linear relationship.

12. The display device of claim 1, wherein the display panel includes a first pixel, a second pixel, a third pixel which emit light of different colors from each other,
wherein the second pixel is disposed in a first pixel row, and
wherein the first pixel and the third pixel are disposed in a second pixel row adjacent to the first pixel row.

13. The display device of claim 12, wherein the input image signal includes a first color signal, a second color signal, a third color signal corresponding to the first pixel, the second pixel, and the third pixel, respectively.

14. The display device of claim 13, wherein the renderer renders the first color signal using a first rendering filter in which the weight is disposed in a first direction,
wherein the renderer renders the second color signal using a second rendering filter in which the weight is disposed in a second direction opposite to the first direction,
wherein the renderer renders the third color signal using a third rendering filter in which the weight is disposed in the first direction.

15. A method of driving a display device, the method comprising:
generating an edge value for detecting an edge of an image using a plurality of filters having different sizes from each other;
calculating a weight based on the edge value; and
converting an input image signal to an output image signal based on the weight.

16. The method of claim 15, wherein the edge value is calculated based on a first edge value for detecting the edge of the image in a first direction and a second edge value for detecting the edge of the image in a second direction crossing the first direction.

17. The method of claim 16, wherein the first edge value is calculated by performing intersection operation of a first sub-edge value calculated based on a first filter having a first size among the plurality of filters, a second sub-edge value calculated based on a second filter having a second size greater than the first size among the plurality of filters, and a third sub-edge value calculated based on a third filter having a third size greater than the second size among the plurality of filters, and
wherein the second edge value is calculated by performing intersection operation of a fourth sub-edge value calculated based on a fourth filter having the first size among the plurality of filters, a fifth sub-edge value calculated based on a fifth filter having the second size among the plurality of filters, and a sixth sub-edge value calculated based on a sixth filter having the third size among the plurality of filters.

18. The method of claim 17, wherein the first sub-edge value is calculated by convolution operation of the input image signal and the first filter,
wherein the second sub-edge value is calculated by convolution operation of the input image signal and the second filter,
wherein the third sub-edge value is calculated by convolution operation of the input image signal and the third filter,
wherein the fourth sub-edge value is calculated by convolution operation of the input image signal and the fourth filter,
wherein the fifth sub-edge value is calculated by convolution operation of the input image signal and the fifth filter, and
wherein the sixth sub-edge value is calculated by convolution operation of the input image signal and the sixth filter.

19. The method of claim 17, wherein the first size, the second size, and the third size are 3 by 3, 5 by 5, and 7 by 7, respectively.

20. The method of claim 17, wherein the first filter, the second filter, the third filter, the fourth filter, the fifth filter, and the sixth filter are
$$[ \begin{matrix}- 1 & - 1 & - 1 \\ 0 & 0 & 0 \\ 1 & 1 & 1\end{matrix} ] , [ \begin{matrix}- 1 & - 1 & - 1 & - 1 & - 1 \\ 0 & 0 & 0 & 0 & 0 \\ 0 & 0 & 0 & 0 & 0 \\ 0 & 0 & 0 & 0 & 0 \\ 1 & 1 & 1 & 1 & 1\end{matrix} ] , \\ [ \begin{matrix}- 1 & - 1 & - 1 & - 1 & - 1 & - 1 & - 1 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 0 & 0 & 0 & 0 & 0 & 0 & 0 \\ 1 & 1 & 1 & 1 & 1 & 1 & 1\end{matrix} ] , [ \begin{matrix}- 1 & 0 & 1 \\ - 1 & 0 & 1 \\ - 1 & 0 & 1\end{matrix} ] , [ \begin{matrix}- 1 & 0 & 0 & 0 & 1 \\ - 1 & 0 & 0 & 0 & 1 \\ - 1 & 0 & 0 & 0 & 1 \\ - 1 & 0 & 0 & 0 & 1 \\ - 1 & 0 & 0 & 0 & 1\end{matrix} ] , and \\ [ \begin{matrix}- 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1 \\ - 1 & 0 & 0 & 0 & 0 & 0 & 1\end{matrix} ] ,$$
respectively.
